(19) United States
(12) Patent Application Publication
(10) Pub. No.: US 2015/0095767 A1
(43) Pub. Date: Apr. 2, 2015

(54) AUTOMATIC GENERATION OF MOBILE SITE LAYOUTS

(71) Applicants: Rachel Ebner, Ra'anana (IL); Shahar Arusi, Moshav Yagal (IL); Dmitry Khalatov, Yokneam (IL); Ariel Tammam, Ramat-Gan (IL); Yahali Sherman, Tel Aviv (IL); Eyal Nathan, Reut (IL)

(72) Inventors: Rachel Ebner, Ra'anana (IL); Shahar Arusi, Moshav Yagal (IL); Dmitry Khalatov, Yokneam (IL); Ariel Tammam, Ramat-Gan (IL); Yahali Sherman, Tel Aviv (IL); Eyal Nathan, Reut (IL)

(21) Appl. No.: 14/044,555

(22) Filed: Oct. 2, 2013

(51) Int. Cl. G06F 17/22

(52) U.S. Cl. CPC G06F 17/2247
USPC 715/238

(57) ABSTRACT

The disclosure generally describes computer-implemented methods, software, and systems for automatically generating mobile site layouts. One example method includes: identifying a portal layout associated with a portal page including one or more portal components, the portal layout including positioning information for the one or more portal components, the positioning information describing how the one or more portal components are to be presented on a rendered display, transforming the portal layout into a mobile portal layout configured to present the one or more portal components on a mobile display particular to a mobile device, the transformation based on one or more mobile layout criteria and performed in response to receiving a request to present the portal page on the mobile device, and presenting the mobile portal layout to the mobile device.

### TECHNICAL FIELD

The present disclosure relates to computer-implemented methods, software, and systems for automatically generating mobile site layouts.

### BACKGROUND

Page layouts for web pages are typically designed with a full desktop or laptop display. As mobile devices continue to flourish, web designers are forced to modify their designs to provide appropriate views on alternative viewing devices, such as smart phones, tablets, and other devices with displays different than those found on desktops, laptops, and other traditional workstations.

### SUMMARY

The disclosure generally describes computer-implemented methods, software, and systems for automatically generating mobile site layouts. One example method includes: identifying a portal layout associated with a portal page including one or more portal components, the portal layout including positioning information for the one or more portal components, the positioning information describing how the one or more portal components are to be presented on a rendered display, transforming the portal layout into a mobile portal layout configured to present the one or more portal components on a mobile display particular to a mobile device, the transformation based on one or more mobile layout criteria and performed in response to receiving a request to present the portal page on the mobile device, and presenting the mobile portal layout to the mobile device.

While generally described as computer implemented software embodied on tangible media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example of a computer system environment for automatically generating mobile site layouts.

FIG. 2 illustrates an example method for automatically generating mobile site layouts in one example implementation of the present disclosure.

FIG. 3 is an example portal page as presented in a desktop or laptop display.

FIG. 4 is an example mobile version of the example portal page of FIG. 3 as transformed and presented on a mobile device.

### DETAILED DESCRIPTION

The present disclosure provides tools, methods, and systems for automatically generating mobile site layouts from sites originally designed for desktop or laptop presentation. In many instances, particularly in the context of a web site, workspace, or other pages, such pages were designed primarily for a two-dimensional desktop view. As users have adopted more frequent mobile computing habits, and as mobile devices have grown in processing power and display capabilities, many sites and workspaces are viewed more frequently on mobile devices of many different shapes and sizes. While the original sites and workspaces may be presented in multiple columns, smartphones and other mobile devices may have limited display space, such that a single or reduced column presentation may be necessary or optimal. The present disclosure describes methods and operations for automatically transforming original sites and workspaces from the traditional desktop display into a suitable mobile display optimized for the user and the user's mobile device.

In many instances, the original web sites and workspaces may be associated with a portal environment, wherein the sites and workspaces include one or more web widgets, portal components, portlets, or other content. Web widgets may comprise a small application with limited functionality that can be embedded into the site. Portlets may include pluggable user interface software components that are managed and displayed in a web portal. Generally, portlets may produce fragments of markup code that are aggregated into a single portal. For consistency, the term portal component will be used to describe these and similar components. These portal components may be presented within a portal page in the portal environment, and may be associated with a default layout associated with the desktop. As described, these components may be laid out in a two-dimensional manner, with multiple columns and rows of such portal components representing a single portal page. A portal layout may be defined which precisely defines the particular layout of a portal page. In some instances, such portal layouts may be dynamically determined based on the user, the user's role, the organization associated with the portal, the portal components themselves—as well as their respective relationships and dependencies, metadata associated with one or more of the portal components, and social data related to the portal page and the portal components themselves.

Various calculations and determinations may be used to determine how to order the portal components from the default portal layout into the single- or reduced-column mobile portal layout of the mobile device. In a simple solution, the portal components can be ordered vertically based on how the portal components appear in a site descriptor file. In a more advanced solution, a reference point may be defined within the default portal layout (e.g., the top-left corner of a rendered version of the portal page) and used to calculate the distance from a particular common reference point on each of the portal components (e.g., the top-left corner of each portal component in the rendered version of the portal page). In the mobile portal layout, the portal components can then be presented in ascending order with respect to the relative distances from the reference point within the default portal layout. Further, additional information may be used along with, or alternatively to, the distance from the reference point in determining the mobile layout order. For example, information on the relative age of particular portal components may be used in the mobile layout determination, as well as information on the relative height of the widgets. This additional information can then be used in the mobile layout algorithm to provide a higher priority to the portal component, and therefore a better (e.g., higher) location in the mobile page layout. Another possible criterion for generating the mobile layout may include an analysis of the context and relationship between portal components. For example, if portal component A sends an event and portal component B listens for and reacts to that event, then portal component A should be presented before portal component B. Similarly, if portal component A and portal component B share a context (i.e., information on state and status is shared between the components), then they should be presented together on the mobile layout to ensure consistency. Other potential considerations are included herein, and will be understood by one of skill in the art.

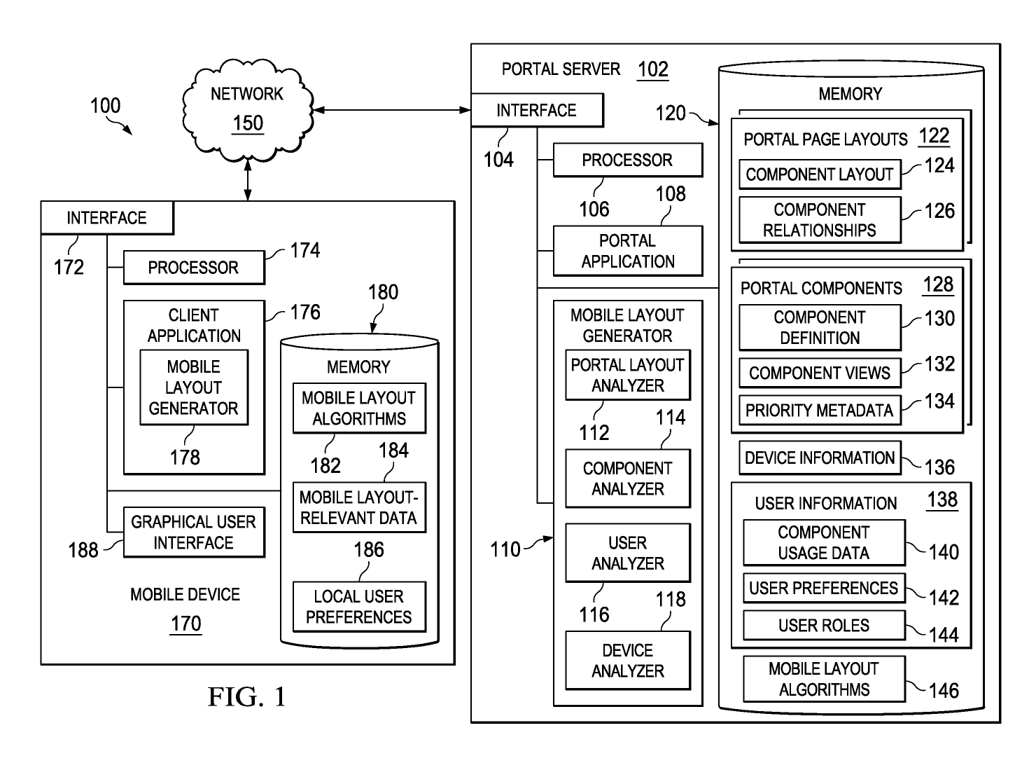

FIG. 1 illustrates an example of a computer system environment 100 for automatically generating mobile site layouts. Specifically, the illustrated environment 100 includes or is communicably coupled with a portal server 102, one or more mobile devices 170, and network 150.

In general, the portal server 102 is a server that stores one or more portal applications 108, where at least a portion of the portal applications 108 are executed via requests and responses sent to users or clients within and communicably coupled to the illustrated environment 100 of FIG. 1. In some implementations, the portal server 102 may store a plurality of various portal applications 108. In other implementations, the portal server 102 may be a dedicated server meant to store and execute only a single portal application 108. In some implementations, the portal server 102 may comprise a Web server, where the portal applications 108 represent one or more Web-based applications accessed and executed by the mobile device 170 via the network 150 or directly at the portal server 102 to perform the programmed tasks or operations of the portal application 108.

At a high level, the portal server 102 comprises an electronic computing device operable to receive, transmit, process, store, or manage data and information associated with the environment 100. Specifically, the portal server 102 illustrated in FIG. 1 is responsible for receiving application requests, for example, portal navigation requests, from one or more client applications 176 associated with the mobile device 170 of the environment 100 and responding to the received requests by processing said requests in the associated portal application 108, and sending the appropriate response from the portal application 108 back to the requesting client application 176.

In some implementations, the portal server 102 processes requests from the mobile device 170 for presenting a portal page associated with a particular layout originally designed for a desktop or laptop display. The portal server 102 can generate, for example, a version of the requested portal page for presentation at the mobile device 170 by transforming the page layout of the requested original portal page into a mobile page layout. In addition to requests received from the mobile device 170, requests may also be sent to the portal server 102 from internal users, external or third-parties, other automated applications, as well as any other appropriate entities, individuals, systems, or computers. Further, while not shown in FIG. 1, desktop clients may also send requests for particular portal pages to the portal server 102, and may receive the original portal pages with their original page layouts in return. In some implementations, various requests can be sent directly to portal server 102 from a user accessing the portal server 102 directly.

As used in the present disclosure, the term “computer” is intended to encompass any suitable processing device. For example, although FIG. 1 illustrates a single portal server 102, environment 100 can be implemented using two or more servers 102, as well as computers other than servers, including a server pool. Indeed, portal server 102 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, illustrated portal server 102 may be adapted to execute any operating system, including Linux, UNIX, Windows, Mac OS®, Java™, Android™, iOS or any other suitable operating system. According to one implementation, portal server 102 may also include or be communicably coupled with an e-mail server, a Web server, a caching server, a streaming data server, a business intelligence server, and/or other suitable server(s).

The portal server 102 also includes an interface 104, a processor 106, and a memory 120. The interface 104 is used by the portal server 102 for communicating with other systems in a distributed environment—including within the environment 100—connected to the network 150; for example, the mobile device, as well as other systems communicably coupled to the network 150 (not illustrated). Generally, the interface 104 comprises logic encoded in software and/or hardware in a suitable combination and operable to communicate with the network 150. More specifically, the interface 104 may comprise software supporting one or more communication protocols associated with communications such that the network 150 or interface's hardware is operable to communicate physical signals within and outside of the illustrated environment 100.

As illustrated in FIG. 1, the portal server 102 includes a processor 106. Although illustrated as a single processor 106 in FIG. 1, two or more processors may be used according to particular needs, desires, or particular implementations of the environment 100. Each processor 106 may be a central processing unit (CPU), a blade, an application specific integrated circuit (ASIC), a field-programmable gate array (FPGA), or another suitable component. Generally, the processor 106 executes instructions and manipulates data to perform the operations of the portal server 102. Specifically, the processor 106 executes the functionality required to receive and respond to requests from the mobile device 170, as well as to analyze portal page content and generate a mobile layout for presentation at the mobile device 170.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The portal server 102 also includes a memory 120, or multiple memories 120. The memory 120 may include any type of memory or database module and may take the form of volatile and/or non-volatile memory including, without limitation, magnetic media, optical media, random access memory (RAM), read-only memory (ROM), removable media, or any other suitable local or remote memory component. The memory 120 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the portal server 102. Additionally, the memory 120 may include any other appropriate data, such as VPN applications, firmware logs and policies, firewall policies, a security or access log, print or other reporting files, as well as others.

As illustrated, memory 120 can include significant sets of information related to automatically generating a mobile site layout of a particular portal page. First, memory 120 includes one or more portal page layouts 122. The portal page layouts 122 can explicitly define a particular design or organization of a portal page, including a particular component layout 124 defining a location of each component within the portal page layout 122. In some instances, the portal page layout 122 may define instructions or algorithms for defining where particular portal components are to be displayed so that each user's particular version of a portal page layout 122 may be defined or determined at runtime based on that user's preferences, prior user interactions, other users' preferences or actions as associated with the portal page or its components, as well as user- and device-specific information determined at runtime. The portal page layout 122 may also include information defining one or more component relationships 126. These component relationships 126 may include portal wiring or other defined connections that define inputs and outputs of particular portal components as connected to one or more other components, such that the components are considered related. Additionally, a portal component may listen to another component or otherwise monitor events triggered by another component and perform responsive actions. In other instances, navigation links between portal components 128 may also be included in the portal relationships. Information on such relationships may be included within the component relationships 126 of the portal page layout 122, or such defined within a particular portal component 128.

Memory 120 further includes one or more portal components 128. The portal components 128, as described above, can be web widgets, portlets, chips, or other similar technologies, which provide functionality and a user interface component in a web site or web portal. The portal components 128 may be defined or represented in any suitable format or language, including, but not limited to, HTML, JavaScript, Objective C, PHP, Perl, Python, and CSS. Each portal component 128 may include a component definition 130, one or more component views 132, and priority metadata 134, as well as other data. The component definition 130 may define one or more particular web services or backend data sources associated with a particular portal component 128, as well as how the portal component 128 may operate or act. In some instances, the component definition 130 may include information on when the particular portal component 128 was created or modified, as well as when the portal component 128 was added to or edited within particular portal pages and their portal page layouts 122. The component views 132 may define the UI aspects of the portal component 128, such as the size and visualizations of the portal component 128. In some instances, a particular portal component 128 may be associated with a plurality of possible views, where particular views are used in different circumstances or based on different criteria. For example, a particular portal component 128 may be associated with a first component view 132 for desktop presentations (e.g., a presentation intended for presentation on a full-scale or traditional web browser) and a second component view 132 for mobile device presentations. Further, the second component view 132 may be used for mobile device presentations having high-speed network connections, while a third component view 132 may be used for mobile device presentations having relatively lower-speed network connections. Any number of component views 132 may be defined for a particular portal component 128. The priority metadata 134 may be information associated with the portal component 128 that describes a relative priority of the portal component 128 as compared to other components. In some instances, the priority metadata 134 can be explicitly set by a developer. In others, the priority metadata 134 may be dynamically determined based on one or more metrics associated with the portal component 128, such as usage data or user preference information. In some algorithms, a high priority may result in the portal component 128 being presented at a relatively higher location in a mobile presentation as compared to where the portal component 128 may otherwise be presented after a mobile layout transformation.

Memory 120 is also illustrated as including a set of device information 136. The device information 136 may define specific hardware and software, as well as their related capabilities, associated with one or more of the mobile devices 170. The device information 136 may be associated with or linked to a device database storing the device-related information. For example, the device information 136 may include information on one or more mobile devices. Information regarding device capabilities may include processor types, speeds, and numbers, a number of processor cores, the amount of RAM and storage of the mobile device, and display size, as well as dynamic information including the mobile device's current network speed and type of connection (e.g., EDGE, LTE, CDMA, WiFi, etc.). In some instances, at least a portion of these capabilities, including the network speed and type of connection, may be identified as requests are received. Additionally, the device information 136 may also store information associated with the particular mobile application or browser associated with or used by a particular device. For example, particular mobile browsers (e.g., Safari, Mobile Firefox, and Chrome for Mobile) and mobile applications with browsing or portal capabilities (e.g., a standalone mobile application) may have different display capabilities. The mobile site layout generated for a particular mobile device 170 may use one or more of these device and application capabilities in determining how to generate a particular mobile site layout.

Memory 120 is also illustrated as including a set of user information 138. User information 138 may be associated with an individual user associated with the mobile device 170, a group of similarly-situated users, or based on user feedback. As illustrated, the user information 138 includes component usage data 140. The component usage data 140 may define how often a particular portal component 128 is interacted with when presented. Highly-used portal components 128 may be provided higher priority in a mobile presentation than lesser-used portal components 128. The component usage data 140 may be based on an individual user's previous usage of portal components 128, as well as an overall or subset of users' usage of the portal components 128. The user information 138 includes user preferences 142, such as those provided by users while viewing a displayed portal previously, among others. For example, if a user hides or rearranges a particular portal component 128 within a portal presentation, such information can be used to raise, lower, or remove a particular portal component 128 from a mobile portal layout. Additionally, explicit user preferences 142 may be defined by the user. As illustrated, information on a particular user's role 144 may be used to determine how the mobile portal layout is to be generated. Information on a particular position within an enterprise or organization may indicate that certain portal components 128 should be prioritized higher or lower relative to others based on the user's role, position, or level of authority.

Memory 120 is also illustrated as including a set of mobile layout algorithms 146. These mobile layout algorithms 146 can be defined by users, developers, or administrators, in some cases to maximize the visibility of important portal components 128 on the mobile device 170. The mobile layout algorithms 146 can define how to transform a portal page layout 122 into a mobile portal page layout for presentation on the mobile device 170. In some instances, multiple sets of criteria can be used to combine considerations and perform a hybrid calculation. A first criteria may be used for an initial organization, with second (and possibly more) criteria used to further refine the initial organization. Any suitable combination of criteria may be used for the mobile layout algorithms 146.

The portal server 102 may include a mobile layout generator 110 for performing the transformation from the portal page layouts 122 to the corresponding mobile portal page layout. The mobile layout generator 110 can identify the appropriate mobile layout algorithm 146 to apply in response to a request from a mobile device 170 to present a mobile portal page. In some instances, the appropriate mobile layout algorithm 146 may be the same for all users of a particular portal page, while in other instances, individuals or groups of users may have different mobile layout algorithms 146 for their requests. The mobile layout generator 110 includes a portal layout analyzer 112, a component analyzer 114, a user analyzer 116, and a device analyzer 118.

The portal layout analyzer 112 can analyze the structure and design, including the component layout 124, of the original portal page layout 122 associated with a particular portal page. The analysis can include a review of a portal component's 128 placement or relative location within a statically- or dynamically-defined portal page layout 122. Additionally, the portal layout analyzer 112 can review any relevant component relationships 126 defined for a particular portal page layout 122.

The component analyzer 114 can analyze the particular portal components 128 included in the portal page layout 122 of the requested portal page. The analysis can include a determination as to whether a particular portal component 128 is assigned a particular priority, whether the portal component 128 includes multiple views 132 (and which to apply, in some cases), as well as other component-specific information. In some instances, the component analyzer 114 may also recognize whether a particular component 128 is related to or otherwise associated with another portal component 128. In some instances, the portal component definition 130 may provide additional or alternative information on such relationships than the relationships identified in the component relationships 126, such as information included within the component definition 130.

The user analyzer 116 can analyze information associated with the particular user of the mobile device 170. The user information identified with the user analyzer 116 may be dynamic information associated with the user, including the user's location or time of the request. The user analyzer 116 can also evaluate user preferences, prior component usage data from the particular user (or a similar group of users), the user's role or position, as well as other user-related information.

The device analyzer 118 can analyze information associated with the particular mobile device 170 providing the request for the portal page. The device analyzer 118 can determine one or more of the type of device 170, the particular capabilities of the device 170, and other device-specific information. In some instances, the device analyzer 118 can also determine the particular application or browser associated with the request.

Using the information collected by its various components, the mobile layout generator 110 can determine the appropriate mobile layout algorithm 146 to apply and use the determined information with the algorithm 146 to perform the appropriate transformations into the mobile page layout. While various elements are described for the mobile layout generator 110, one or more of the elements may be combined into one or more elements, or split into additional elements, as appropriate. Further, while illustrated all within the portal server 102, one or more of the elements may be external to the portal server 102. In one implementation, the mobile layout generator 110 may be located at the mobile device 170, such that transformations are performed at the mobile device 170 after receiving the original portal page layout 122.

Network 150 facilitates wireless or wireline communications between the components of the environment 100 (i.e., between the portal server 102 and the one or more mobile devices 170), as well as with any other local or remote computer, such as additional clients, servers, or other devices communicably coupled to network 150, including those not illustrated in FIG. 1. In the illustrated environment, the network 150 is depicted as a single network, but may be comprised of more than one network without departing from the scope of this disclosure, so long as at least a portion of the network 150 may facilitate communications between senders and recipients. In some instances, one or more of the components associated with the portal server 102 may be included within network 150 as one or more cloud-based services or operations. For example, at least a portion of the portal server 102 and the mobile layout generator 110 in particular may be within the network 150, and operate at least partially within or as a cloud-based system, including, in some instances, multiple remote processors performing the operations described herein.

The network 150 may be all or a portion of an enterprise or secured network, while in another instance, at least a portion of the network 150 may represent a connection to the Internet. In some instances, a portion of the network 150 may be a virtual private network (VPN). Further, all or a portion of the network 150 can comprise either a wireline or wireless link. Example wireless links may include 802.11a/b/g/n, 802.20, WiMax, LTE, and/or any other appropriate wireless link. In other words, the network 150 encompasses any internal or external network, networks, sub-network, or combination thereof operable to facilitate communications between various computing components inside and outside the illustrated environment 100. The network 150 may communicate, for example, Internet Protocol (IP) packets, Frame Relay frames, Asynchronous Transfer Mode (ATM) cells, voice, video, data, and other suitable information between network addresses. The network 150 may also include one or more local area networks (LANs), radio access networks (RANs), metropolitan area networks (MANs), wide area networks (WANs), all or a portion of the Internet, and/or any other communication system or systems at one or more locations.

The illustrated environment of FIG. 1 also includes one or more mobile devices 170. Each of these devices may be any computing device operable to connect to or communicate with at least the portal server 102 via the network 150 using a wireline or wireless connection. In general, the mobile devices 170 comprise electronic computer devices operable to receive, transmit, process, and store any appropriate data associated with the environment 100 of FIG. 1. These devices 170 can connect to the portal server 102, for instance, using HTTP or RFC protocols depending on client technologies and implementation preferences.

The illustrated environment 100 includes the mobile device 170, or multiple mobile devices 170. The mobile device 170 may be any mobile computing device operable to connect to or communicate with at least the portal server 102 via the network 150 using a wireline or wireless connection. In general, the mobile device 170 comprises an electronic computer device operable to receive, transmit, process, and store any appropriate data associated with the environment 100 of FIG. 1.

The illustrated mobile device 170 includes a client application 176. The client application 176 is any type of application that allows the mobile device 170 to request and view content on the mobile device 170. In some implementations, the client application 176 can be and/or include a web browser. In some implementations, the client-application 176 can use parameters, metadata, and other information received at launch to access a particular set of data from the portal server 102. Once a particular client application 176 is launched, a user may interactively process a task, event, or other information associated with the server 102, including one or more portal applications 108 and portal pages. Further, although illustrated as a single client application 176, the client application 176 may be implemented as multiple client applications in the mobile device 170. In some instances, the client application 176 may be an agent or client-side version of the one or more portal applications 108.

The client application 176 is further illustrated as including a mobile layout generator 178. As described above, some or all of the functionality associated with the mobile layout generator 110 of the portal server 102 may be located or executed at the mobile device 170. Different mobile devices 170 may have different levels of functionality for the mobile layout generator 178, or may perform different operations associated with the mobile layout generator 178 at different times based on dynamic conditions, such as network speed or type. For example, when the mobile device 170 is connected to a high-speed connection, more processing associated with the mobile layout transformation may occur at the mobile device 170 and its mobile layout generator 178, while slower-speed connections may perform more of the transformation operations at the portal server 102 and its mobile layout generator 110. The mobile layout generator 178 may include some or all of the elements as illustrated in the mobile layout generator 110 of the portal server 102, as well as additional or alternative elements.

The illustrated mobile device 170 further includes an interface 172, a processor 174, and a memory 180. The interface 172 is used by the mobile device 170 for communicating with other systems in a distributed environment—including within the environment 100—connected to the network 150; for example, the portal server 102, as well as other systems communicably coupled to the network 150 (not illustrated). Generally, the interface 172 comprises logic encoded in software and/or hardware in a suitable combination and operable to communicate with the network 150. More specifically, the interface 172 may comprise software supporting one or more communication protocols associated with communications such that the network 150 or interface's hardware is operable to communicate physical signals within and outside of the illustrated environment 100.

As illustrated in FIG. 1, the mobile device 170 includes processor 174. Although illustrated as a single processor 174 in FIG. 1, two or more processors 174 may be used according to particular needs, desires, or particular implementations of the environment 100. Each processor 174 may be a central processing unit (CPU), an application specific integrated circuit (ASIC), a field-programmable gate array (FPGA), or another suitable component. Generally, the processor 174 executes instructions and manipulates data to perform the operations of the mobile device 170. Specifically, the processor 174 executes the functionality required to send requests to the portal server 102 and to receive and process responses from the portal server 102, as well as the normal operations of the mobile device 170.

Further, the illustrated mobile device 170 includes a graphical user interface (GUI) 188. The GUI 188 interfaces with at least a portion of the environment 100 for any suitable purpose, including generating a visual representation of a Web browser. In particular, the GUI 188 may be used to view and navigate various Web pages located both internally and externally to the portal server 102, including one or more portal pages. The GUI 188 associated with each mobile device 170 may comprise a graphical user interface operable, for example, to allow the user of a mobile device 170 to interface with at least a portion of the portal application 108 and its associated operations and functionality, as well as other applications. Generally, the GUI 188 provides the particular user with an efficient and user-friendly presentation of business data provided by or communicated within the system. The GUI 188 may comprise a plurality of customizable frames or views having interactive fields, pull-down lists, and buttons operated by the user. For example, the GUI 188 may provide interactive elements that allow a user to interact with a particular portal page, as well as other components within and/or external to the environment 100. The different portions of the portal server's functionality may be presented and accessible to the user through the GUI 188, such as through the client application 176. Generally, the GUI 188 may also provide general interactive elements that allow a user to access and utilize various services and functions of a particular portal application 108. The GUI 188 may present information associated with the client application 176 for viewing and interaction. In general, the GUI 188 is often configurable, supports a combination of tables and graphs (bar, line, pie, status dials, etc.), and is able to build real-time portals, where tabs are delineated by key characteristics (e.g., site or micro-site). Therefore, the GUI 188 contemplates any suitable graphical user interface, such as a combination of a generic web browser, intelligent engine, and command line interface (CLI) that processes information in the platform and efficiently presents the results to the user visually.

The illustrated mobile device 170 also includes memory 180, or multiple memories 180. The memory 180 may include any memory or database module and may take the form of volatile or non-volatile memory including, without limitation, magnetic media, optical media, random access memory (RAM), read-only memory (ROM), removable media, or any other suitable local or remote memory component. The memory 180 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the mobile device 170. Additionally, the memory 180 may include any other appropriate data, such as VPN applications, firmware logs and policies, firewall policies, a security or access log, print or other reporting files, as well as others.

As illustrated, memory 180 can include one or more mobile layout algorithms 182, mobile layout-relevant data 184, and local user preferences 186. The sets of data can be used to allow the mobile device 170 to perform the operations necessary to automatically generate the mobile layout at the mobile device 170, in connection with the mobile layout generator 178. The mobile layout algorithms 182 may be similar to the mobile layout algorithms 146. The mobile layout-relevant data 184 may include any information items similar to those described within memory 120, as well as any other suitable information relevant to generating the mobile layout. Local user preferences 186 may include locally-defined user preferences that can be used to influence how the mobile layout is to be generated.

There may be any number of mobile devices 170 associated with, or external to, the environment 100. For example, while the illustrated environment 100 includes one mobile device 170, alternative implementations of the environment 100 may include multiple mobile devices 170 communicably coupled to the portal server 102 and/or the network 150, or any other number suitable to the purposes of the environment 100. Additionally, there may also be one or more additional mobile devices 170 external to the illustrated portion of environment 100 that are capable of interacting with the environment 100 via the network 150. Further, the term “client” and “user” may be used interchangeably as appropriate without departing from the scope of this disclosure. Moreover, while the mobile device 170 is described in terms of being used by a single user, this disclosure contemplates that many users may use one computer, or that one user may use multiple computers.

The illustrated mobile device 170 is intended to encompass any mobile computing device with a non-traditional display such as a smartphone, personal data assistant (PDA), tablet computing device, or any other suitable mobile device. For example, the mobile device 170 may comprise a computer that includes an input device, such as a keypad, touch screen, or other device that can accept user information, and an output device that conveys information associated with the operation of the portal server 102 or the mobile device 170 itself, including digital data, visual information, or a GUI 188, as shown with respect to the mobile device 170.

While FIG. 1 is described as containing or being associated with a plurality of elements, not all elements illustrated within environment 100 of FIG. 1 may be utilized in each alternative implementation of the present disclosure. For example, although FIG. 1 depicts a particular environment 100, any suitable alternative environments and implementations are considered. Additionally, one or more of the elements described herein may be located external to environment 100, while in other instances, certain elements may be included within, or as a portion of, one or more of the other described elements, as well as other elements not described in the illustrated implementation. Further, certain elements illustrated in FIG. 1 may be combined with other components, as well as used for alternative or additional purposes in addition to those purposes described herein.

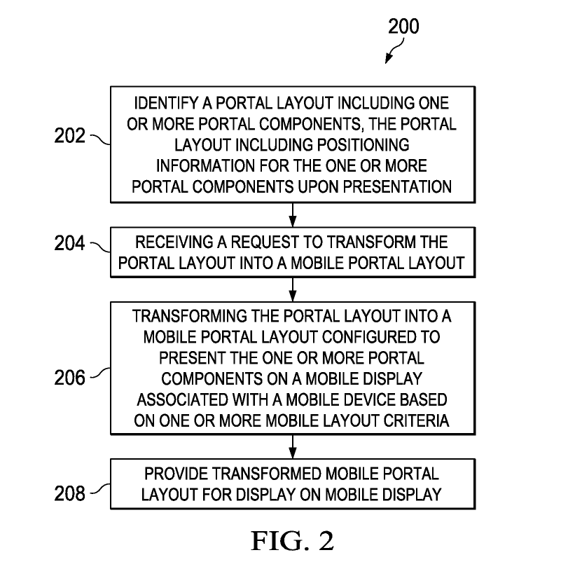

FIG. 2 illustrates an example method 200 for automatically generating mobile site layouts in one example implementation of the present disclosure. For clarity of presentation, the description that follows generally describes method 200 in the context of FIG. 1. However, it will be understood that method 200 may be performed, for example, by any other suitable system, environment, software, and hardware, or a combination of systems, environments, software, and hardware, as appropriate. For example, one or more of the portal server, the client, or other computing device (not illustrated) can be used to execute method 200 and obtain any data from the memory of the client, the portal server, or the other computing device (not illustrated).

At 202, a portal layout associated with a particular portal page is identified, where the portal layout includes one or more portal components. The portal layout can include positioning information for the one or more portal components for when the portal page is presented on a traditional display, such as a desktop or laptop using a complete browser (e.g., Microsoft's Explorer, Google's Chrome, Mozilla's Firefox, or Apple's Safari, among others). The identification of 202 may be performed in response to a request to access and present the particular portal page. Where the request originated at a mobile device, there may be a need to transform the defined portal layout into a mobile portal layout for presentation on the mobile device. In such situations, a request to transform the portal layout into the mobile portal layout is received at 204.

At 206, the portal layout is transformed into a mobile portal layout, where the mobile portal layout is configured and can be used to present the one or more portal components of the particular portal page on a mobile display associated with the mobile device. Specifically, the transformation operations to be performed can be determined based on one or more mobile layout criteria. The mobile layout criteria can be defined by a develop, an administrator, or a user with sufficient authorization, and can be used to determine how portal components associated with the portal page should be ordered and arranged in a relatively limited display on the mobile device. In some instances, a particular mobile layout algorithm can be determined for ordering the portal components in the mobile layout. The mobile layout algorithms can take one or more mobile layout criteria into consideration when preparing and performing the transformation operations.

In one example, the mobile layout algorithm may be based on particular portal component's relative locations within the original portal page layout. In a simple example, the portal components may be presented in the mobile page layout in an order going from left to right from row to row. In another more advanced example, the portal components may be analyzed within the original page layout to determine their relative distance from a particular reference point within a rendered version of the portal page. For example, the top-left of the rendered portal page may be used as a reference point. For each portal component, the distance from that reference point may be calculated to the top-left, or another suitable point, on the visual representation of the portal component in the rendered version of the portal page. The portal components closest to the reference point may be ordered higher in the mobile layout than those farther away based on an assumption that the most important portal components would be located closer to the reference point.

In another example, the mobile layout algorithm may consider the frequency of use of particular portal components. The frequency of such use may be based on a user's personal use of the portal component or on the use of a group of users, thereby providing some social aspects to the transformation. Using this information, more frequently used or interacted-with portal components may be given higher priority in the mobile layout than those portal components which are not as highly used or interacted with. In some cases, where a group's usage is considered in the algorithm, the group of users considered may be associated with one or more demographics similar to the user associated with the request for the portal page. For example, usage information for portal components of other users in the same role or position within the organization may be considered. In some instances, both the user's individual usage and a related group of user's usage may both be considered in the algorithm. In some cases, the user's individual usage may be given a relatively higher weight than the group's usage in the algorithm.

In another example, the positioning of individual portal components can be based on relationships between two or more portal components. For example, if one portal component interacts with another portal component, those portal components may be kept together when generating the mobile portal layout. Such instances may include situations where a first portal component's output is connected to a second portal component's input, such that the two components are directly connected. In other examples, a first portal component may not be directly connected to a second portal component, but may instead listen for events triggered by or from the second portal component. In some instances, an action associated with the first portal component may trigger navigation to the second portal component. In such cases, those portal components may be considered related and placed together if the mobile layout algorithm includes component relationships as a criterion.

In another example, the mobile layout algorithm may consider defined priorities or importance of particular portal components within the portal page. For example, portal component developers, users, administrators, or others may identify particular portal components as high-priority or of a certain importance. Relatively higher ranked components may be moved to the top of the mobile layout, in some instances.

In another example, the specific user agent, browser, or application associated with the requesting user may be used to determine how particular portal components will be displayed. For example, certain portal components may be viewed in one aspect within one application, while they may be viewed in a second aspect in another application. In some instances, a portal component may not be compatible with a particular application, such as a Flash-based portal component in a Mobile Safari browser.

In another example, the particular mobile device type and/or the mobile device capabilities may be used in a mobile layout algorithm. A mobile device with one set of characteristics may be presented with a different mobile layout than another device with a different set of characteristics. These distinctions may occur frequently with the different display sizes and capabilities of today's mobile devices. For example, a tablet computer may be able to display two columns of portal components while a smartphone may only be able to display a single column of portal components. In some instances, portal components may also have different UIs associated with them, with which UI to be displayed determined based on the mobile device's capabilities and specifications. Similarly, the type and speed of a network connection can be used in some mobile layout algorithms.

In some instances, mobile layout algorithms may consider dynamic information associated with the user and/or the request. For example, the mobile layout algorithm may change the order or presentation of particular portal components based on a time of the request for the portal. The time-based determination may use user information to determine popular portal components at certain times of day, both by the individual user, by all users, or by similar users. Additionally, the user's location may be used to determine how to generate the mobile layout. If the user is at the office, for instance, certain portal components may be more likely to be used than if the user is at home or traveling. Such information can be measured for one user, multiple users, or similar users, and used to optimize the ordering of the portal components.

In some instances, user preferences and/or prior actions may be used to determine the order of the portal components in the mobile layout. In one example, a user may have indicated that a particular portal component should be “locked” into a particular location during previous interactions. In another example, the user may have hidden or removed a portal component such that the mobile layout should not include or should minimize the importance of that portal component. In some instances, users may be able to rearrange portal components in either the original or mobile layouts. In those instances, the prior user rearrangement may be used to inform the mobile layout algorithm how to arrange the current mobile layout.

In another example, social information collected from other users may be used to determine the appropriate ordering for a particular mobile layout algorithm. In those examples, the relative usage of a particular component can be compared to other components and used to determine a relative placement of the particular portal component. In some instances, the relative usage may be associated with all users, users similar to the current user, or any other suitable grouping or set of other users. In addition to a usage amount, user ratings associated with individual portal components may be collected and considered within the mobile layout algorithm.

These example mobile layout criteria are not meant to be limiting, and can include any other suitable criteria. Further, particular mobile layout algorithms can include two or more of the described or other criteria to provide advanced ordering of portal components. Further, as described, in addition to the particular order of the portal components, the mobile layout algorithm may also provide rules on which version of a particular portal component to present in certain instances.

At 208, the transformed mobile portal layout is provided for display on the mobile device's display in the order as determined by the mobile layout algorithm.

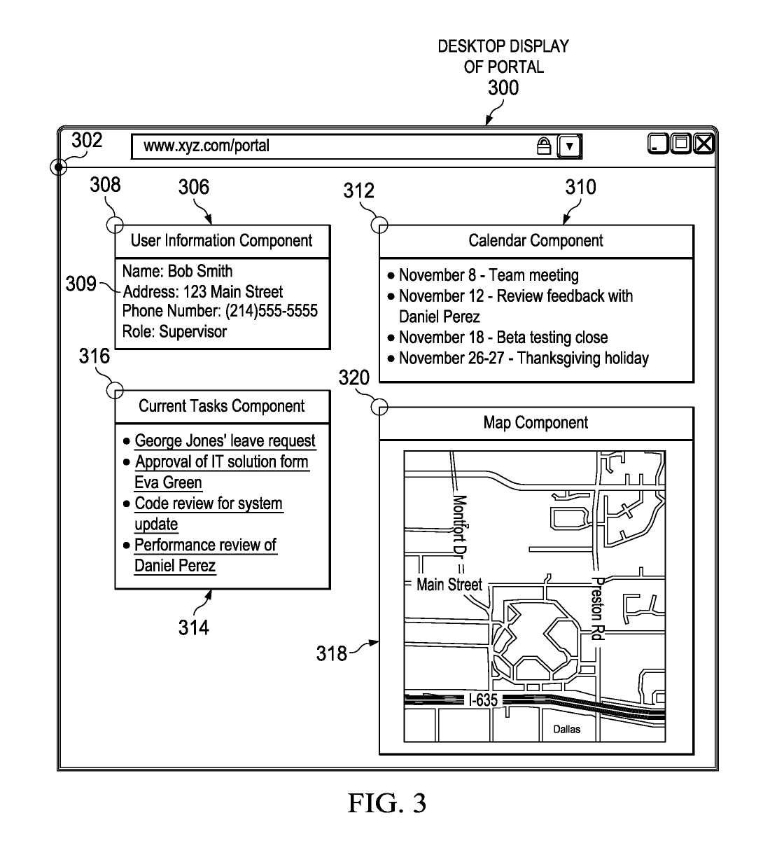

FIG. 3 is an example portal page 300 as presented in a desktop or laptop display. As illustrated, the current view of the portal page 300 includes four portal components (306, 310, 314, and 318) presented in a two-column format. Other implementations may have more or less columns, or may not be column-based. In the present example, the mobile layout algorithm applies two criteria: (1) the relative distances of each portal component from a particular reference point in the portal page and (2) relationships between the portal components.

A reference point 302 is determined by the system, and represents the top-left portion of the rendered portal page 300. On each portal component, the component's top-left position is also used as a reference point, as shown by 308, 312, 316, and 320. Those reference points are then measured to reference point 302 to determine the relative distance of each portal component. For the first analysis of the mobile layout algorithm, the order of the portal components is as follows: component 306, component 310, component 316, and component 320.

An analysis of the portal components themselves determines that portal component 306 and portal component 318 are highly related, as the particular address 309 of the user described in portal component 306 is used to generate a map of the user's address in portal component 318. When the address 309 is modified, the map in portal component 318 is updated in response. Based on this relationship, the mobile layout algorithm results in a modification to the order originally determined based on the relative distances from the reference point 302.

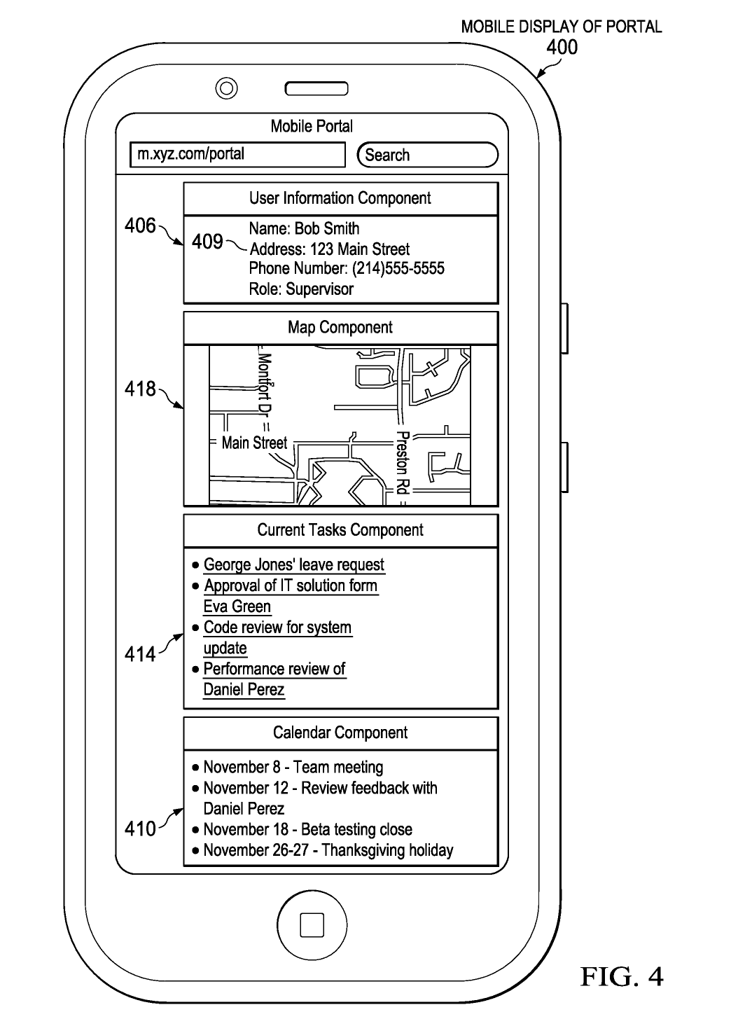

FIG. 4 is an example mobile version of the example portal page 300 of FIG. 3 as transformed and presented on a mobile device, now illustrated as mobile portal page 400. As illustrated, the portal component order is as follows: the user information component 406, the map component 418, the current tasks component 414, and the calendar component 410. As described above, if the ordering was based solely on the relative distance from the reference point 302, the order of the components in the mobile version would be as follows: user information component 406, current task component 414, calendar component 410, and map component 418. In other words, the relationship between the user information component 406 (306 in FIG. 3) and the map component 418 (318 in FIG. 3) raises the placement of the map component 418 in the mobile portal page.

The preceding figures and accompanying descriptions illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate. For example, any suitable algorithm and/or criteria may be used in generating a mobile portal page layout.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method executed by one or more processors, the method comprising:
identifying a portal layout associated with a portal page including one or more portal components, the portal layout including positioning information for the one or more portal components, the positioning information describing how the one or more portal components are to be presented on a rendered display;
transforming the portal layout into a mobile portal layout configured to present the one or more portal components on a mobile display particular to a mobile device, the transformation based on one or more mobile layout criteria and performed in response to receiving a request to present the portal page on the mobile device; and
presenting the mobile portal layout to the mobile device.

2. The method of claim 1, wherein the one or more mobile layout criteria include a distance from a reference point of each portal component to a reference point of the rendered display, and transforming the portal layout into the mobile portal layout includes ordering the one or more portal components in ascending order based on the distance from the reference point of each portal component to the reference point of the rendered display.

3. The method of claim 2, wherein the reference point of each portal component comprises a top-left corner of each portal component, and wherein the reference point of the rendered display comprises the top-left corner of the rendered display.

4. The method of claim 1, wherein the one or more mobile layout criteria include a determination of usage data associated with the one or more portal components, and transforming the portal layout into the mobile portal layout includes ordering the one or more portal components in descending order of usage based on the usage data.

5. The method of claim 4, wherein the mobile device is associated with a particular user, and wherein the usage data is specific to the particular user.

6. The method of claim 1, wherein the one or more mobile layout criteria include device attributes associated with the mobile device, and transforming the portal layout into the mobile portal layout includes displaying each of the one or more portal components on the based on the device attributes.

7. The method of claim 6, wherein the device attributes include at least one of a type of processor, a number of processor cores, an amount of memory, a current network speed, or a current network type.

8. The method of claim 1, wherein the one or more mobile layout criteria include device location criteria indicating a current location of the device, and wherein transforming the portal layout into the mobile portal layout includes displaying each of the one or more portal components based on the device location criteria.

9. The method of claim 8, wherein displaying each of the one or more portal components includes hiding at least one of the portal components.

10. The method of claim 1, wherein transforming the portal layout into the mobile portal layout includes substituting a mobile version of at least one of the portal components configured to be displayed on the mobile display.

11. The method of claim 1, wherein transforming the portal layout into the mobile portal layout is performed at the mobile device.

12. The method of claim 11, wherein identifying the portal layout associated with the portal page includes receiving the portal layout from a portal server associated with the portal page in response to a request for the portal page.

13. The method of claim 1, wherein transforming the portal layout into the mobile portal layout is performed at a portal server associated with the portal page.

14. The method of claim 13, wherein identifying the portal layout associated with the portal page includes selecting the portal layout associated with the portal page in response to receiving a request for the portal page from the mobile device.

15. The method of claim 1, wherein the one or more mobile layout criteria include relationship data describing interactions between the one or more portal components, and transforming the portal layout into the mobile portal layout includes ordering the one or more portal components so that portal components that interact with each other are displayed adjacent to each other on the mobile display.

16. The method of claim 1, wherein the one or more mobile layout criteria include site editing data describing an edit history of the portal page, wherein the edit history of the portal page includes an order in which the one or more portal components were added to the portal page, and transforming the portal layout into the mobile portal layout includes ordering the one or more portal components according to the order in which the one or more portal components were added to the portal page.

17. A computer-implemented method executed by one or more processors, the method comprising:
identifying a page layout associated with a page resource including one or more page components, the page layout including positioning information for the one or more page components, the positioning information describing how the one or more page components are to be presented on a rendered display;
transforming the page layout into a mobile page layout configured to present the one or more page components on a mobile display particular to a mobile device, the transformation based on one or more mobile layout criteria and performed in response to identifying the page layout associated with the page resource; and
presenting the mobile page layout to the mobile device.

18. A system, comprising:
a processor;
a computer-readable storage medium coupled to the processor having instructions stored thereon which, when executed by the processor, cause the processor to perform operations comprising:
identifying a portal layout associated with a portal page including one or more portal components, the portal layout including positioning information for the one or more portal components, the positioning information describing how the one or more portal components are to be presented on a rendered display;
transforming the portal layout into a mobile portal layout configured to present the one or more portal components on a mobile display particular to a mobile device, the transformation based on one or more mobile layout criteria and performed in response to receiving a request to present the portal page on the mobile device; and
presenting the mobile portal layout to the mobile device.

19. The system of claim 18, wherein the one or more mobile layout criteria include a distance from a reference point of each portal component to a reference point of the rendered display, and transforming the portal layout into the mobile portal layout includes ordering the one or more portal components in ascending order based on the distance from the reference point of each portal component to the reference point of the rendered display.

20. A computer program product embodied in a non-transitory computer-readable storage medium and comprising instructions that when executed by a processor, the method comprising:
identifying a portal layout associated with a portal page including one or more portal components, the portal layout including positioning information for the one or more portal components, the positioning information describing how the one or more portal components are to be presented on a rendered display;
transforming the portal layout into a mobile portal layout configured to present the one or more portal components on a mobile display particular to a mobile device, the transformation based on one or more mobile layout criteria and performed in response to receiving a request to present the portal page on the mobile device; and
presenting the mobile portal layout to the mobile device.
